(19) United States
(12) Patent Application Publication
(10) Pub. No.: US 2009/0227411 A1
(43) Pub. Date: Sep. 10, 2009

(54) Power Device for an Electric Grease Gun

(76) Inventor: Wen-I GUO, Taiping City (TW)

Correspondence Address: Dr. BANGER SHIA, 102 Lindencrest Ct., Sugar Land, TX, 77479-5201, US

(21) Appl. No.: 12/043,413

(22) Filed: Mar. 6, 2008

(51) Int. Cl. F16H 48/10

(52) U.S. Cl. 475/150

(57) ABSTRACT

A power device for an electric grease gun comprises a first planetary disk, a first planetary gear set, a positioning bearing, a second planetary disk, a second planetary gear set and a ring gear. The first planetary gear set is pivotally disposed on the first planetary disk. The second planetary disk is assembled corresponding to the first planetary disk, and the positioning bearing is pivotally disposed between the first and second planetary disks. The second planetary gear set is pivotally disposed on the second planetary disk and is engaged with the combining portion of the first planetary disk. The ring gear is defined with a through hole for receiving the first and second planetary disks. The first and second planetary gear sets rotate in the ring gear via the positioning bearing, so as to perform speed reduction. In addition, the positioning bearing is used to reduce friction.

### BACKGROUND OF THE INVENTION

1. Field of the Invention

The present invention relates to an electric grease gun, and more particularly to a power device for an electric grease gun with low abrasion and high precision.

2. Description of the Prior Art

In order to maintain the operation smoothness of a mechanical structure, lubricating oil is usually provided between the components of the structure to reduce friction. In order to reduce the manual effort, an electric grease gun 10 appeared in the market as shown in FIG. 1, which comprises a bearing seat 11. One side of the bearing seat 11 is provided with a power device 20, and the other side of the bearing seat 11 is provided with a receiving device 12 for reception of grease. The power device 20 comprises a gear reduction device 21 connected to the power source. The gear reduction device 21 is connected to an eccentric wheel 13, and the eccentric wheel 13 is eccentrically combined with a screw 14 which drives a sliding block 15 to move. The sliding block 15 is combined with a pushing rod 16 which pushes grease. The gear reduction device 21 comprises a motor 22 and a plurality of reduction gear sets 23. However, such a conventional electric grease gun still has the following disadvantages:

The reduction gear sets 23 are abutted against one another, once the motor 22 rotates the reduction gear sets 23 to reduce the rotating speed, the abrasion caused by the friction of the reduction gear sets 23 will cause the relative movement of the reduction gear sets 23. As a result, the problem of inaccurate positioning is produced, such that the reduction gear sets 23 are unable to perform speed reduction precisely, and the life of the reduction gear sets 23 will be reduced. Moreover, the replacement and maintenance of the reduction gear sets 23 is also a headache for the user.

The present invention has arisen to mitigate and/or obviate the afore-described disadvantages.

### SUMMARY OF THE INVENTION

The primary objective of the present invention is to provide a power device for an electric grease gun which realizes the effect of low abrasion and high precision via a positioning bearing.

To achieve the objective of the present invention, the power device for an electric grease gun comprises a first planetary disk, a first planetary gear set, a positioning bearing, a second planetary disk, a second planetary gear set and a ring gear.

One end of the first planetary disk is formed with a combining portion.

The first planetary gear set is pivotally disposed on the first planetary disk.

The second planetary disk is assembled corresponding to the first planetary disk, and the positioning bearing is pivotally disposed between the first and second planetary disks. The combining portion of the first planetary disk is inserted in the second planetary disk. One end of the second planetary disk is formed with a combining portion engaged with a feeding device.

The second planetary gear set is pivotally disposed on the second planetary disk and is engaged with the combining portion of the first planetary disk.

The ring gear is defined with a through hole for receiving the first and second planetary disks. The first and second planetary gear sets rotate in the ring gear.

The other end of the first planetary disk is formed with a first assembling portion, and the first assembling portion is formed with a second assembling portion for insertion of a transmission part of the motor. The first planetary disk is formed with at least one groove. The first planetary gear set comprises at least two-planetary gears that are pivotally disposed in the groove of the first planetary disk via a bolt, such that the planetary gears of the first planetary gear set are engaged with the transmission portion of the motor.

The positioning bearing comprises an inner ring and an outer ring. The inner ring is disposed on the outer ring, and a plurality of rolling members is provided between the inner ring and the outer ring.

The other end of the second planetary disk is formed with at least one receiving portion for receiving the positioning bearing, and the outer ring of the positioning bearing is abutted against the receiving portion. In addition, the inner ring of the positioning bearing is abutted against the first planetary disk, and the combining portion of the first planetary disk is inserted in the receiving portion of the second planetary disk. The second planetary disk is formed with at least one groove.

The second planetary gear set comprises at least two planetary gears that are pivotally disposed in the groove of the second planetary disk via a bolt, such that the planetary gears of the second planetary gear set are engaged with the combining portion of the first planetary disk.

An inner periphery of the ring gear is engaged with the planetary gears of the first and second planetary gear sets.

With the relative movement of the positioning bearing which is located between the first and second planetary disks, the first and second planetary disks can be positioned on the positioning bearing to change the rotating speed as desired. Moreover, the rolling members of the positioning bearing are used to reduce friction, such that the abrasion between the first and second planetary disks is reduced, and the life of the power device is prolonged.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a conventional electric grease gun;

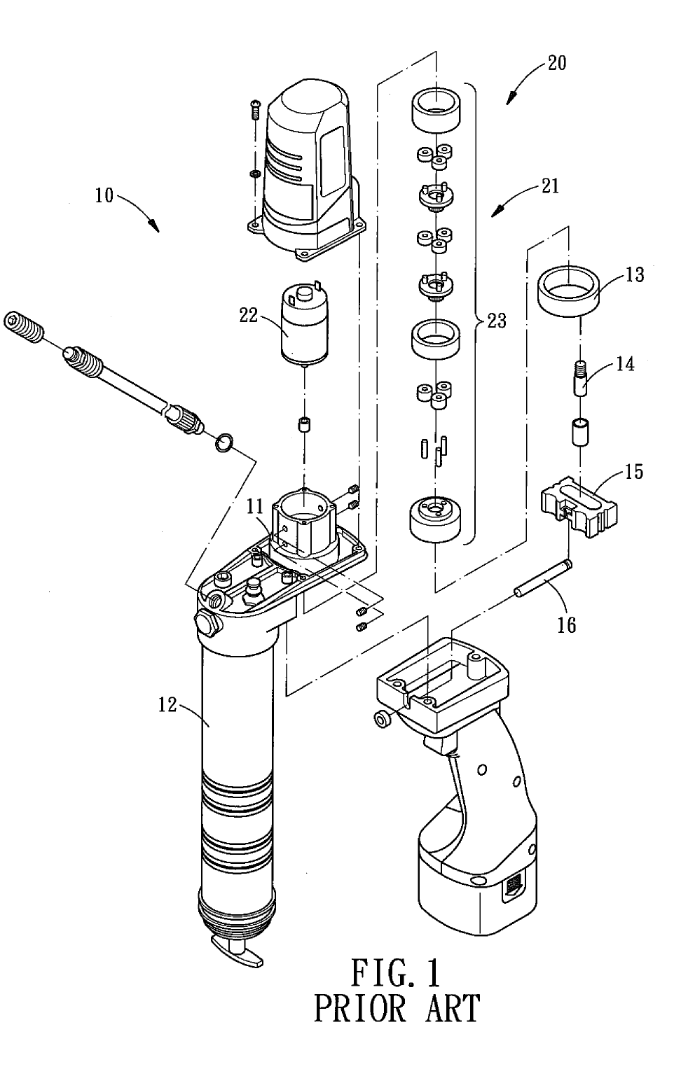

FIG. 2 is a perspective view of an electric grease gun in accordance with the present invention;

FIG. 3 is an exploded view of a power device and a bearing seat in accordance with the present invention;

FIG. 4 is an assembly perspective view of the power device in accordance with the present invention; and

FIG. 5 is an exploded view of a feeding device and the bearing seat in accordance with the present invention.

### DETAILED DESCRIPTION OF THE PREFERRED EMBODIMENTS

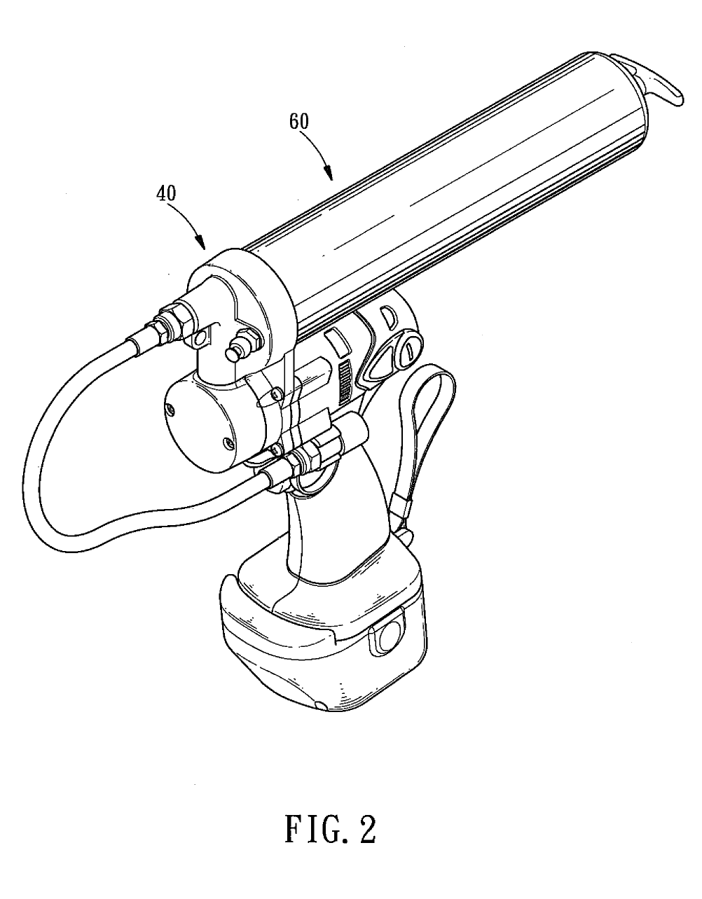

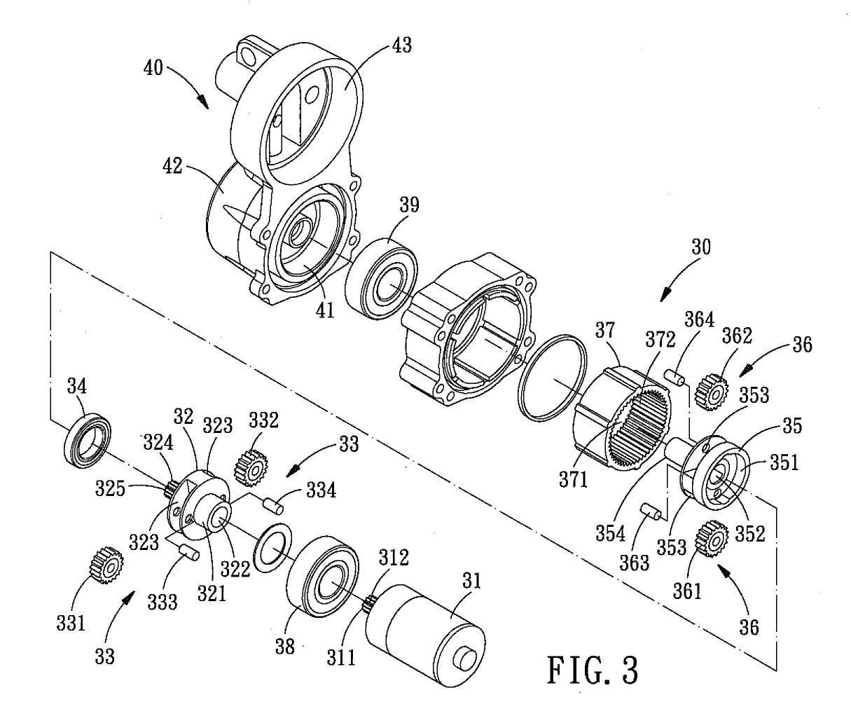

Referring to FIGS. 2 and 3, a power device 30 for an electric grease gun in accordance with the present invention comprises a motor 31, a first planetary disk 32, a first planetary gear set 33, a positioning bearing 34, a second planetary disk 35, a second planetary gear set 36, a ring gear 37 and two restricting bearings 38.

The motor 31 comprises a stator and a mover. The mover magnetically moves with respect to the stator. An axis passes through the mover of the motor 31, and one end of the axis is provided with a transmission part 311. Around the outer periphery of the transmission part 3 11 is formed a toothed surface 312.

One end of the first planetary disk 32 is formed with a first assembling portion 321 which is in the form of a hollow cylinder, and a second assembling portion 322 which is in the form of hole and is provided for insertion of the transmission part 311 of the motor 31 being coaxial with the first assembling portion 321. Both sides of the first planetary disk 32 are formed with a groove 323 in communication with the second assembling portion 322. The other end of the first planetary disk 32 is formed with a combining portion 324 which is in the form of a hollow cylinder. Around the outer periphery of the combining portion 324 is formed a toothed surface 325.

The first planetary gear set 33 comprises two planetary gears 331, 332 that are pivotally disposed in the grooves 323 of the first planetary disk 32 via bolts 333, 334, such that the planetary gears 331, 332 are engaged with the toothed surface 312 of the transmission portion 311 of the motor 31.

The positioning bearing 34 comprises an inner ring and an outer ring. An outer periphery of the inner ring is slidably disposed on an inner periphery of the outer ring, and a plurality of rolling members (such as ball or roller) (not shown) is provided between the inner ring and the outer ring.

One end of the second planetary disk 35 is formed with a first receiving portion 351 which is in the form of a hollow cylinder, and a second receiving portion 352 which is in the form of hole being coaxial with the first receiving portion 351. An inner diameter of the first receiving portion 351 is larger than that of the second receiving portion 352. The first receiving portion 351 is provided for receiving the positioning bearing 34. The outer ring of the positioning bearing 34 is abutted against the inner periphery of the first receiving portion 351, and the inner ring of the positioning bearing 34 is abutted against the first planetary disk 32. The combining portion 324 of the first planetary disk 32 is inserted in the second receiving portion 352 of the second planetary disk 35. Both sides of the second planetary disk 35 are formed with a groove 353 in communication with the second receiving portion 352. The other end of the second planetary disk 35 is formed with a combining portion 354 which is in the form of a hollow cylinder.

The second planetary gear set 36 comprises two planetary gears 361, 362 that are pivotally disposed in the grooves 353 of the second planetary disk 35 via bolts 363, 364, such that the planetary gears 361, 362 are engaged with the toothed surface 325 of the combining portion 324 of the first planetary disk 32.

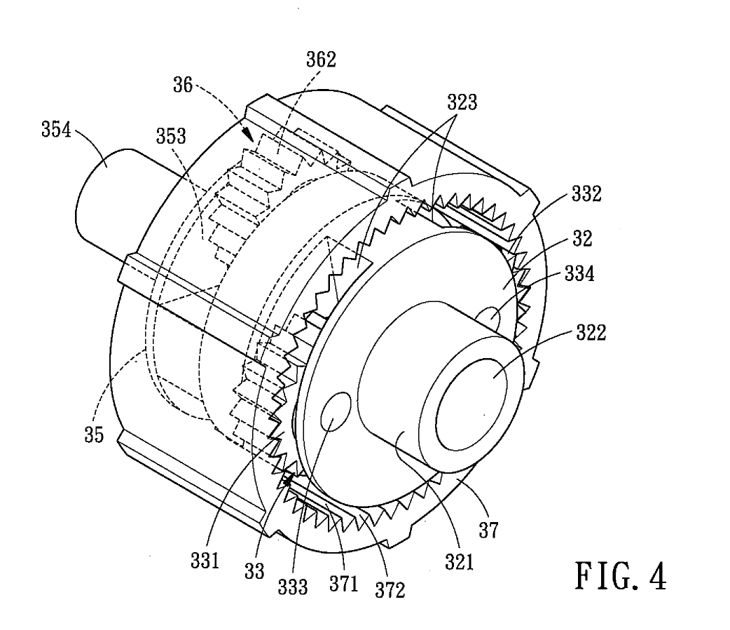

Referring to FIG. 4, the ring gear 37 is defined with a through hole 371, and around the inner periphery of the through hole 317 is formed a toothed surface 372. The through hole 371 of the ring gear 37 is provided for receiving the first and second planetary disks 32, 35, such that the planetary gears 331, 332 of the first planetary gear set 33 and the planetary gears 361, 362 of the second planetary gear set 36 are engaged with the toothed surface 372 of the ring gear 37, respectively.

Each of the restricting bearings 38, 39 comprises an inner ring and an outer ring. An outer periphery of the inner ring is slidably disposed on an inner periphery of the outer ring, and a plurality of rolling members (such as ball or roller) (not shown) is provided between the inner ring and the outer ring. The inner ring of the restricting bearing 38 is provided for insertion of the first assembling portion 321 of the first planetary disk 32, and the inner ring of the restricting bearing 39 is provided for insertion of the combining portion 354 of the second planetary disk 35.

Referring to FIGS. 3-5, the electric grease gun comprises a bearing seat 40 having a first assembling portion 41, a second assembling portion 42 and a third assembling portion 43. The first assembling portion 41 is connected to the second assembling portion 42, and the third assembling portion 43 is mounted at an upper portion of the first and second assembling portions 41, 42.

The first assembling portion 41 is provided for assembling the power device 30.

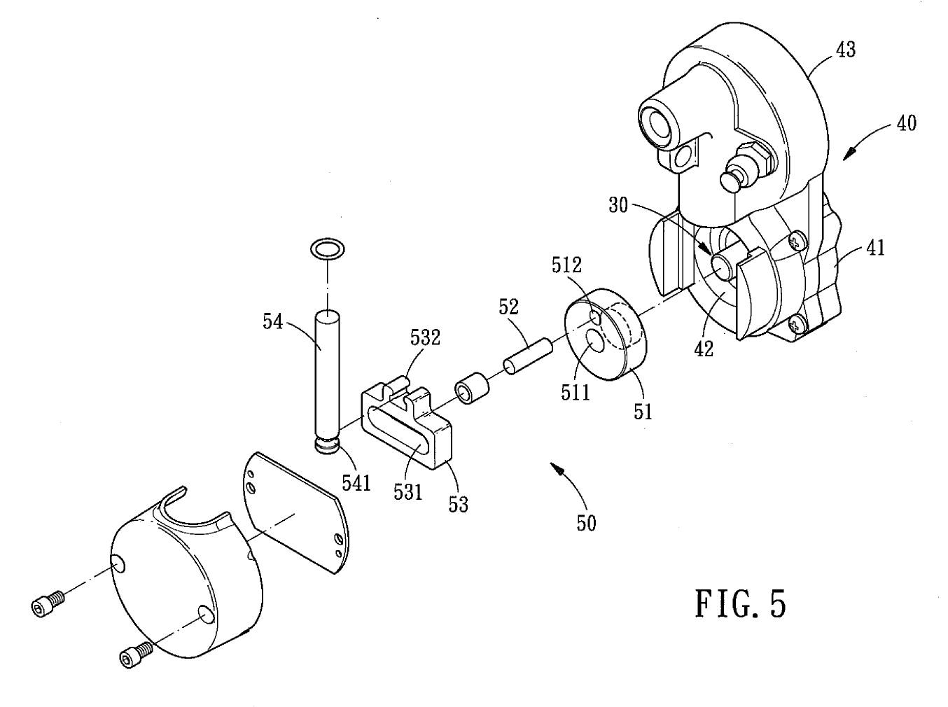

The second assembling portion 42 is provided for assembling a feeding device 50. Referring to FIG. 5, the feeding device 50 comprises a first rotating block 51, an inserting rod 52, a second rotating block 53 and a pushing rod 54. The first rotating block 51 is defined with a positioning hole 511 and an eccentric hole 512. The positioning hole 511 is located in the center of the first rotating block 51 and is provided for insertion of the combining portion 354 of the second planetary disk 35. The eccentric hole 512 is located beside the positioning hole 511 and is provided for insertion of the inserting rod 52. One end of the inserting rod 52 is inserted in the eccentric hole 512 of the first rotating block 51, and the other end of the inserting rod 52 is inserted in the second rotating block 53. The second rotating block 53 is defined with a restricting hole 531 for insertion of the other end of the inserting rod 52. In an outer periphery of the second rotating block 53 is formed an assembling portion 532 which comprises two opposite hooks. The assembling portion 532 of the second rotating block 53 is engaged with the pushing rod 54. One end of the pushing rod 54 is formed with an engaging portion 541 engaged in the assembling portion 532 of the second rotating block 53. The third assembling portion 43 is provided for assembling an oil container 60.

The feeding device 50 of the electric grease gun is driven by the power device 30 to press against the oil container 60, so as to supply grease.

For a better understanding of the present invention, its operations and functions, reference should be made to FIGS. 2-5 again:

The power device 30 is pivotally disposed on the bearing seat 40 via the restricting bearings 38, 39. When the user drives the motor 31, the toothed surface 312 of the transmission part 311 of the motor 31 will drive the planetary gears 331, 332 of the first planetary gear set 33 to rotate, such that the first planetary disk 32 will rotate in the ring gear 37, so as to perform a first speed reduction.

When the first planetary disk 32 rotates, the toothed surface 325 of the combining portion 324 of the first planetary disk 32 will drive the planetary gears 361, 362 of the second planetary gear set 36 to rotate, such that the second planetary disk 35 will rotate in the ring gear 37, so as to perform a second speed reduction.

With the relative movement of the inner ring and the outer ring of the positioning bearing 34 which is located between the first and second planetary disks 32, 35, the first and second planetary disks 32, 35 can be positioned on the positioning bearing 34 to change the rotating speed as desired. Moreover, the rolling members of the positioning bearing 34 are used to reduce friction, such that the abrasion between the first and second planetary disks 32, 35 is reduced.

To summarize, a power device for an electric grease gun of the present invention comprises a first planetary disk, a first planetary gear set, a positioning bearing, a second planetary disk, a second planetary gear set and a ring gear. The first planetary gear set is pivotally disposed on the first planetary disk. The second planetary disk is assembled corresponding to the first planetary disk. The positioning bearing is pivotally disposed between the first and second planetary disks. The second planetary gear set is pivotally disposed on the second planetary disk and is engaged with the first planetary disk. The ring gear is defined with a through hole for receiving the first and second planetary disks. The first and second planetary gear sets rotate in the ring gear via the positioning bearing, so as to perform speed reduction. In addition, the positioning bearing is used to reduce friction.

While we have shown and described various embodiments in accordance with the present invention, it should be clear to those skilled in the art that further embodiments may be made without departing from the scope of the present invention.

What is claimed is:

1. A power device for an electric grease gun being disposed on an electric grease gun to cooperate with a motor and a feeding device, comprising:
a first planetary disk, one end of which being formed with a combining portion;
a first planetary gear set being pivotally disposed on the first planetary disk and engaged with the motor;
a positioning bearing;
a second planetary disk being assembled corresponding to the first planetary disk, the positioning bearing being pivotally disposed between the first and second planetary disks, the combining portion of the first planetary disk being inserted in the second planetary disk, one end of the second planetary disk being formed with a combining portion engaged with the feeding device;
a second planetary gear set being pivotally disposed on the second planetary disk and engaged with the combining portion of the first planetary disk; and
a ring gear being defined with a through hole for receiving the first and second planetary disks, the first and second planetary gear sets being engaged with an inner periphery of the ring gear.

2. The power device for an electric grease gun as claimed in claim 1, wherein the motor comprises a stator and a mover, the mover magnetically moves with respect to the stator, one end of the mover is provided with a transmission part;
the other end of the first planetary disk is formed with a first assembling portion, the first assembling portion is formed with a second assembling portion for insertion of the transmission part of the motor, the first planetary disk is formed with at least one groove;
the first planetary gear set comprises at least two planetary gears that are pivotally disposed in the groove of the first planetary disk via a bolt, such that the planetary gears of the first planetary gear set are engaged with the transmission portion of the motor;
the positioning bearing comprises an inner ring and an outer ring, the inner ring is disposed on the outer ring, a plurality of rolling members is provided between the inner ring and the outer ring;
the other end of the second planetary disk is formed with at least one receiving portion for receiving the positioning bearing, and the outer ring of the positioning bearing is abutted against the receiving portion, the inner ring of the positioning bearing is abutted against the first planetary disk, the combining portion of the first planetary disk is inserted in the receiving portion of the second planetary disk, the second planetary disk is formed with at least one groove;
the second planetary gear set comprises at least two planetary gears that are pivotally disposed in the groove of the second planetary disk via a bolt, such that the planetary gears of the second planetary gear set are engaged with the combining portion of the first planetary disk; and
the inner periphery of the ring gear is engaged with the planetary gears of the first and second planetary gear sets.

3. The power device for an electric grease gun as claimed in claim 2, wherein the first assembling portion is formed at the other end of the first planetary disk, a second assembling portion for insertion of the transmission part of the motor is coaxial with the first assembling portion, the groove of the first planetary disk is in communication with the second assembling portion; and
the other end of the second planetary disk is formed with a first receiving portion, a second receiving portion is coaxial with the first receiving portion, an inner diameter of the first receiving portion is larger than that of the second receiving portion, the first receiving portion is provided for receiving the positioning bearing, the outer ring of the positioning bearing is abutted against an inner periphery of the first receiving portion, such that the combining portion of the first planetary disk is inserted in the second receiving portion of the second planetary disk.

4. The power device for an electric grease gun as claimed in claim 1, wherein the feeding device comprises a first rotating block, an inserting rod, a second rotating block and a pushing rod, the first rotating block is defined with a positioning hole and an eccentric hole, the positioning hole is located in a center of the first rotating block and is provided for insertion of the second planetary disk, the eccentric hole is located beside the positioning hole and is provided for insertion of the inserting rod, one end of the inserting rod is inserted in the eccentric hole of the first rotating block, the other end of the inserting rod is inserted in the second rotating block, the second rotating block is defined with a restricting hole for insertion of the other end of the inserting rod, the second rotating block is formed with an assembling portion engaged with the pushing rod, and one end of the pushing rod is formed with an engaging portion engaged with the assembling portion of the second rotating block.
